(19) United States
(12) Patent Application Publication
(10) Pub. No.: US 2009/0062975 A1
(43) Pub. Date: Mar. 5, 2009

(54) DISPLAY SYSTEM

(76) Inventor: Henryk Strzeletz, Dallas, PA (US)

Correspondence Address: GREENBERG & LIEBERMAN, LLC, 2141 WISCONSIN AVE, N.W., SUITE C-2, WASHINGTON, DC, 20007, US

(21) Appl. No.: 12/039,494

(22) Filed: Feb. 28, 2008

Related U.S. Application Data
(60) Provisional application No. 60/892,063, filed on Feb. 28, 2007.

(51) Int. Cl. G01C 21/00

(52) U.S. Cl. 701/26

(57) ABSTRACT

Abstract A mobile, real-time visual information method and system to provide motorists stuck in traffic congestion the opportunity to receive instantaneous and up-to-the-second news, traffic, weather and other relevant information that is localized to that specific location by combining various transmissions with a prominent and safe display system. A display screen on a truck is deployed to a location of interest, such as a region of roadway prior to a traffic jam. The display screen then shows motorists alternate routes before the motorists encounter the traffic jam.

### CONTINUITY DATA

This is a non-provisional patent application of provisional patent application No. 60/892,063, filed on Feb. 28, 2007, and priority is claimed thereto.

### FIELD OF THE INVENTION

The present invention concerns mobile real-time visual information, and more particularly, the present invention is a high-tech informational method that instantaneously provides an endless amount of information in real time that is prominently displayed on the outside of moving vehicles.

### BACKGROUND OF THE INVENTION

We are living in what has been dubbed the “Information Age.” News, weather, e-mail, sports, video and virtually any other type of communication imaginable is transmitted through the air every day at all hours. The mediums may be satellite antennas, cellular phones, wired systems or wireless communication among others. We currently live in a society where news and information is a 24-hour occurrence that does not stop for anything.

In relation to motorists, they are often stuck in lengthy traffic jams. Whether it is the vast freeways of Southern California or the 495-Beltway in Washington, D.C. to countless locations in between, motorists often find themselves spending a considerable amount of time on the road. Moreover, with the amazing system of roads that have evolved over the years, motorists continue to spend a lot of time traveling in vehicles even if the traffic is not as extreme as described above. And again, while all this travel takes place, the world continues to spin in all its information.

One time-tested item that motorists have used for information has been the radio. Of course the radio is not visual in either its traditional form or satellite. In addition, a motorist often cannot listen to music and hear information by merely using the radio. And in this visual society of immediate Internet information, other options are desired. This notion is proven by the fact that countless Americans are not only talking on their cellular phones while driving, but also sending text messages and logging onto the Internet via their phones. Real-time sports scores, down-to-the-minute news, traffic information, current weather conditions and forecasts, and even lottery numbers are available to virtually anyone with a cellular phone. In fact, it is very likely that a motorist will seek information on traffic or weather issues via the Internet than the radio.

Of course some places have installed menial informational items. For example, cities such as New York and Cleveland display news tickers in heavily congested traffic areas. Of course, these tickers are not updated in real-time. Other areas display the temperature. Many cities also have emergency sirens to warn of impending danger, although the details and significance of these methods are not well known to the general public. All this leaves us with a void in our visual, real-time information while traveling.

Based on this void, there is a need for what essentially can be described as mobile Internet displays that can move within traffic in a safe manner while updating the information in real time. The present invention satisfies that need by equipping vehicles such as larger trucks with high-quality screens capable of receiving and displaying instantaneous communications in real time. The practical aspect of the present invention is that motorists stuck in traffic can easily see real-time information in regard to news, traffic, weather and sports. For example, during a traffic jam, the present invention can display an aerial view of the situation and even provide alternate routes as the situation progresses. The present invention also can provide an explanation of the cause of congestion and detail the progress in real time. The present invention can even be used to warn motorists to expect certain weather conditions such as tornado, snow or hail, as the information becomes available to them in their unique locations. The applications of the present invention are endless.

### SUMMARY OF THE INVENTION

The present invention is a real-time visual information method that takes the concept of immediate information while on the move and combines it with such practices as billboards and taxicab advertisements.

Essentially, the present invention has a display screen that is attached to a mobile vehicle such as a truck or van. Someone either in the truck with a wireless Internet connection or someone from a distant computer can transmit the desired information to each truck. A wireless Internet receiver will have its own identity as it accepts the information as it comes in. Once the transmission reaches the wireless Internet receiver, connections will display the visual image emanating from the wireless Internet receiver onto a display screen that is connected to the truck by these wired connections and secure physical connections. A wireless apparatus also can be attached to the display screen that would limit the use of wires. In addition, the display screen can be of any quality, including but not limited to, high definition. The display screen of the present invention also would be encased in a protective material in order to protect it from the elements, including sun, rain, snow, cold, wind, dust and road salt.

Once the information is projected onto the display screen, motorists would be able to view the information in day or night conditions. According to the present invention, a fleet of trucks could be deployed and positioned at various times in various areas to, for example, lead and/or guide traffic around a traffic jam by showing low traffic routes and alternate traffic routes on one or more display screens on each truck. Visual, real-time information would continue to be updated and visible on the sides of the trucks where the display screens are located. Incidentally, the trucks and Internet transmission receiver can accommodate multiple display screens.

### BRIEF DESCRIPTION OF THE DRAWINGS

FIG. 1 shows a flow chart of the present invention.

FIG. 2 shows a general view of the placement of the display screen (100) of the present invention.

### DETAILED DESCRIPTION OF THE PREFERRED EMBODIMENT

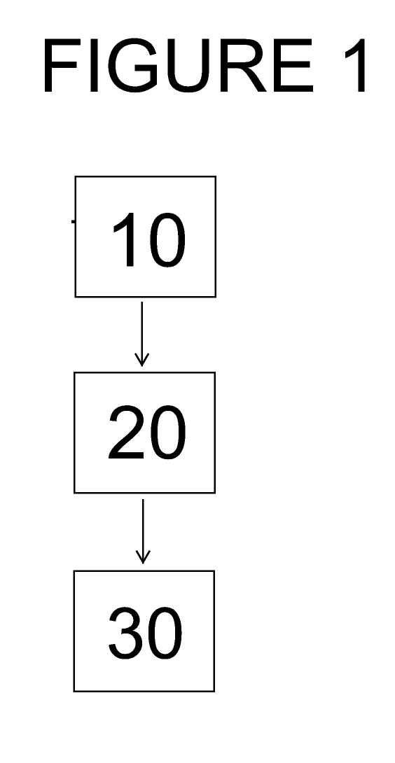

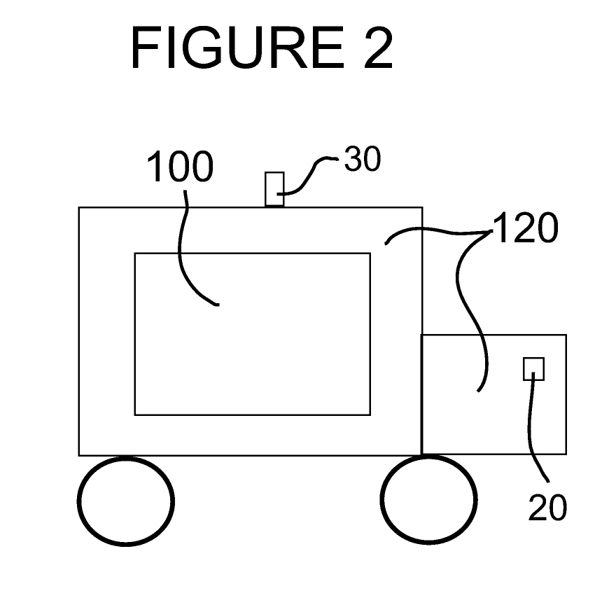

As shown in FIG. 1, there are essentially three phases of transmission involved in the present invention. The first phase is that involving the Internet transmission (10). The Internet transmission (10) can be located anywhere in the world, including but not limited to the inside of a truck itself. According to the present invention, the Internet transmission (10) is transmitted to the wireless truck receiver (20) activated while the truck is deployed. The wireless truck receiver (20) is then capable of receiving a constant stream of Internet data from the Internet transmission (10). This allows for real-time updates and transmissions to continue. Once the wireless truck receiver (20) collects the steady flow of information, it immediately is routed to the display screen receiver (30), preferably wirelessly. As the display screen receiver (30) collects this information, the display screen receiver (30) directs a visual Internet image onto the display screen (100) as seen in FIG. 2. The sequence as shown in FIG. 1 is virtually seamless and instantaneous as the visual information travels from the Internet transmission (10) to the wireless truck receiver (20), and then ultimately to the display screen receiver (30).

A truck (120) is deployed to any location. Bridges, tunnels, highways, parking lots and virtually any place on the roads are prime examples of locations where a truck (120) is deployed and ready under the method of the present invention to utilize the wireless truck receiver (20). Moreover, when the truck (120) is deployed, the truck (120) can be moving with the flow of traffic. If there is an emergency situation, the truck (120) can be deployed such that the truck (120) moves through traffic, indicating emergency status and indicating emergency travel routes, for example. In this example, the truck (120) could guide cars around an emergency situation or bring rescue vehicles directly to an emergency situation. The practical applications are endless in regard to the public service of the present invention, so long as it is conducted in a safe and productive manner.

The type of transmission for the Internet transmission (10) is as endless as what can be found on the Internet. Typical examples as related by the present invention include news, traffic and weather information. The Internet transmission (10) can be in general terms such as a news ticker or a more focused transmission directly related to the circumstances of the area where the truck is deployed. The Internet transmission (10) is transmitted to the wireless truck receiver (20) via a number of means. Typically, the transmission can be made from traditional wireless communication with a direct and distinct connection between the Internet transmission (10) and the wireless truck receiver (20).

FIG. 2 shows a general positioning of the actual display screen (100) as it is securely mounted onto the side of a truck (120) in a prominent fashion. Visual images are relayed to the display screen receiver (30) from the wireless truck receiver (20), and the visual images are shown on the display screen (100) to be seen by nearby motorists. The size and convention of the display screen (100) can vary, but it should be noted that a large display screen (100), that nearly covers the entire side of a truck (120), as shown in FIG. 2, is designed to present a large and clearly visible screen of information during times of serious traffic congestion in order to preserve safety. The display screen (100) constantly can update the real-time visual information as such information is received by wireless truck receiver (20), routed to the display screen receiver (30), and ultimately to display screen (100). In addition, the display screen (100) of the present invention is protected from the elements of nature with an enclosure material, such as waterproof, scratchproof, and temperature resistant material of conventional nature, that shields the display screen (100) from elements such as sun, heat, cold, road salt, moisture and dirt.

I claim:

1. A display system, comprising:
attaching at least one display screen to at least one mobile vehicle;
transmitting information to the at least one mobile vehicle from a remote location; and
displaying the information on the at least one display screen.

2. The display system of claim 1, further comprising encasing the at least one display screen in a protective material.

3. The display system of claim 1, wherein said transmitting information to the at least one mobile vehicle from a remote location is accomplished using a wireless Internet connection.

4. The display system of claim 1, further comprising deploying and positioning the at least one mobile vehicle to guide traffic around a traffic jam.

5. The display system of claim 1, further comprising showing low traffic routes on the at least one display screen.

6. The display system of claim 1, further comprising showing alternate routes for traffic on the at least one display screen.

7. The display system of claim 1, further comprising updating visual, real-time information on the at least one display screen.

8. The display system of claim 1, further comprising moving the at least one mobile vehicle through traffic, indicating emergency status, and indicating emergency travel routes.

9. The display system of claim 1, further comprising moving the at least one mobile vehicle to bring rescue vehicles to an emergency situation.

10. The display system of claim 2,
wherein said transmitting information to the at least one mobile vehicle from a remote location is accomplished using a wireless Internet connection;
further comprising deploying and positioning the at least one mobile vehicle to guide traffic around a traffic jam;
further comprising showing low traffic routes on the at least one display screen;
further comprising showing alternate routes for traffic on the at least one display screen;
further comprising updating visual, real-time information on the at least one display screen;
further comprising moving the at least one mobile vehicle through traffic, indicating emergency status, and indicating emergency travel routes; and
further comprising moving the at least one mobile vehicle to bring rescue vehicles to an emergency situation.
